(19) United States
(12) Patent Application Publication
(10) Pub. No.: US 2026/0138693 A1
(43) Pub. Date: May 21, 2026

(54) AUTONOMOUS VEHICLE AUTOMATED MODULAR EXCHANGE AND ESCAPE WHEEL INDEXING SYSTEMS AND METHODS

(71) Applicant: David W. Carroll, Grantsburg, WI (US)

(72) Inventor: David W. Carroll, Grantsburg, WI (US)

(21) Appl. No.: 19/394,833

(22) Filed: Nov. 19, 2025

Related U.S. Application Data
(60) Provisional application No. 63/722,587, filed on Nov. 19, 2024.
(60) Provisional application No. 63/757,479, filed on Feb. 12, 2025.
(60) Provisional application No. 63/817,139, filed on Jun. 3, 2025.
(60) Provisional application No. 63/862,264, filed on Aug. 12, 2025.

(51) Int. Cl. B62D 63/02

(52) U.S. Cl. CPC B62D 63/025

(57) ABSTRACT

AV systems and methods utilizing a passenger pod selectively coupled to a power module to perform one or more of a full exit operation, a partial exit operation, and an exchange operation. Automated components provide a nested set of body and wheel suspension on a single tray to release or capture the passenger pod while also providing wheel contact of a just released or recaptured passenger pod. This passenger pod enclosure can use composite shell materials and integrate a capture/release shape for an indexing system. A variety of passenger pod shapes and application purposes can be employed.

### CROSS-REFERENCE TO RELATED APPLICATIONS

This Non-Provisional Patent application claims the benefit of the filing date of U.S. Provisional Application No. 63/722,587 filed Nov. 19, 2024 and entitled “Two-Stage Separable Autonomous Electronic Vehicles and Methods”; U.S. Provisional Application No. 63/757,479 filed Feb. 12, 2025 and entitled “Automated Exchange and Exit System for Autonomous Vehicles”; U.S. Provisional Application No. 63/817,139 filed Jun. 3, 2025 and entitled “AV Tire Index Pod Module Exchange and Escape System”; U.S. Provisional Application No. 63/862,264 filed Aug. 12, 2025 and entitled “Autonomous Vehicle Automated Modular Exchange and Escape Wheel Indexing System”; the entire teachings of each of which are incorporated herein by reference.

### BACKGROUND

The present disclosure relates to autonomous vehicles (AVs). More particularly, it relates to systems and methods for a modular AV with separable power module and passenger pod components.

Autonomous and semi-autonomous vehicles continue to evolve toward modular architectures that separate propulsion, at least partial sensing, and at least partial control systems to form the passenger-carrying structure. In many developing platforms, a primary vehicle “power module” incorporates propulsion hardware, energy storage, steering systems, and computational units for navigation and motion control. A detachable “passenger pod” or cabin can then be mounted to the power module to provide occupant seating, cargo space, climate systems, and user interfaces. This modular approach offers manufacturing flexibility, supports multiple passenger pod configurations, and can facilitate reconfiguration of the vehicle for different use cases.

Prior system for securing a passenger pod to a power module have primarily relied on manual or service-assisted attachment mechanisms. In many configurations, mechanical locking structures, electrical connectors, and communication interfaces must be manually engaged or disengaged when installing or removing a passenger pod. Such approaches limit reconfiguration flexibility and do not readily support the dynamic safety capabilities expected of modern autonomous vehicles.

Important progress toward solving these limitations is reflected in Carroll, U.S. Pat. No. 11,618,474 (“Carroll '474 Patent”), the entire teachings of which are incorporated herein by reference. The AV's of the Carroll '474 Patent include a passenger pod that is separable from a power module (with the power module including the vehicle's primary batteries, wheels, etc.). Moreover, the Carroll '474 Patent discloses systems and methods for automated and controlled separation of the passenger pod from the power module under certain conditions, such as in response to a determined impending collision, when a user desires to swap out the passenger pod, etc. By integrating predictive vehicle-sensing data with automated coupling-release mechanisms, the Carroll '474 Patent enables a passenger pod to be separated from the power platform and sent along a determined safest path when onboard perception systems determine that a crash is imminent. This technology represents a significant advancement in occupant protection, introducing a fundamentally new paradigm in which a vehicle's structural configuration can change autonomously as part of its safety response or to swap out passenger pods.

Further revolutionary features of the Carroll '474 Patent lies in its use of the power module's own tires, motors, and steering system to impart a controlled directional influence on the released passenger pod, for example during an emergency separation sequence. After the pod is decoupled, the power module can be operated to apply traction forces, yaw control, and controlled acceleration or deceleration to move the passenger pod into a safer direction. This propulsion-assisted direction control functionality transformed separation of the passenger pod from a mere mechanical event into a coordinated, dynamic, safety-optimized maneuver.

Any improvements to the foundations established by the Carroll '474 Patent would be well-received, for example enhancement that further facilitate sending the passenger pod during a safety exit operation and/or as part of an automate exchange operation in which a released passenger pod is moved off of the power platform for storage or a new passenger pod is loaded onto the power platform.

### SUMMARY

The inventor of the present disclosure has recognized the need to improve upon the disclosures of the Carroll '474 Patent. Some aspects of the present disclosure provide ways to implement the escape and exchange different modules using a nested and automated interconnect system. It is a robotic-like set of coordinated autonomous motions performing the tasks of exchanging pods and exiting from hazardous situations. It extends the power of AI into the Physical AI realm to empower it to meet consumer desires for automated mobile transport with improved variety and safety.

It optionally provides the space for a rear-only entry to reduce parts and thus costs and offers the space between the front and rear wheels for many internal passenger pod layouts.

### BRIEF DESCRIPTION OF THE DRAWINGS

FIG. 1 is a block diagram schematically representing an autonomous vehicle (AV) in accordance with principles of the present disclosure.

FIG. 2 schematically illustrates portions of a full exit operation in accordance with principles of the present disclosure.

FIG. 3A is a perspective view of an AV in accordance with principles of the present disclosure.

FIG. 3B is a simplified end view of the AV of FIG. 3A.

FIG. 4 is a simplified end view of an AV in accordance with principles of the present disclosure.

FIG. 5 is a block diagram schematically representing an AV in accordance with principles of the present disclosure.

FIG. 6A is a simplified end view of the AV of FIG. 5.

FIG. 6B is a simplified side view of portions of the AV of FIG. 6A.

FIG. 7 is an enlarged, simplified cross-sectional view of portions of an AV in accordance with principles of the present disclosure.

FIG. 8A is an enlarged side view of portions of a capture and release mechanism and a suspension system of the AV of FIG. 7.

FIG. 8B is perspective view of a portion of the capture and release mechanism of FIG. 8A.

FIG. 9A is an enlarged, simplified cross-sectional view of portions of an AV in accordance with principles of the present disclosure.

FIG. 9B is a top view of the portions of the AV of FIG. 9A.

FIG. 10 schematically illustrates operation of an indexing system of the AV of FIG. 9A in arranging a wheel into contact with a passenger body.

FIG. 11 is a simplified side view of portions of an indexing system useful with the AVs of the present disclosure.

FIG. 12 is a rear perspective view of an AV in accordance with principles of the present disclosure.

FIG. 13 is a simplified side view of portions of the AV of FIG. 12 in performing an exchange operation.

FIG. 14 is a simplified top plan view of portions of an AV in accordance with principles of the present disclosure.

FIG. 15A is an enlarged top view of a portion of the AV of FIG. 14, taken along the line 15A.

FIG. 15B is an enlarged, simplified cross-sectional view of the AV of FIG. 14, taken along the line 15B-15B.

FIG. 16 is a simplified top plan view of portions of an AV in accordance with principles of the present disclosure.

FIG. 17 is an enlarged side view of wiring connection system useful with the AVs of the present disclosure.

### DETAILED DESCRIPTION

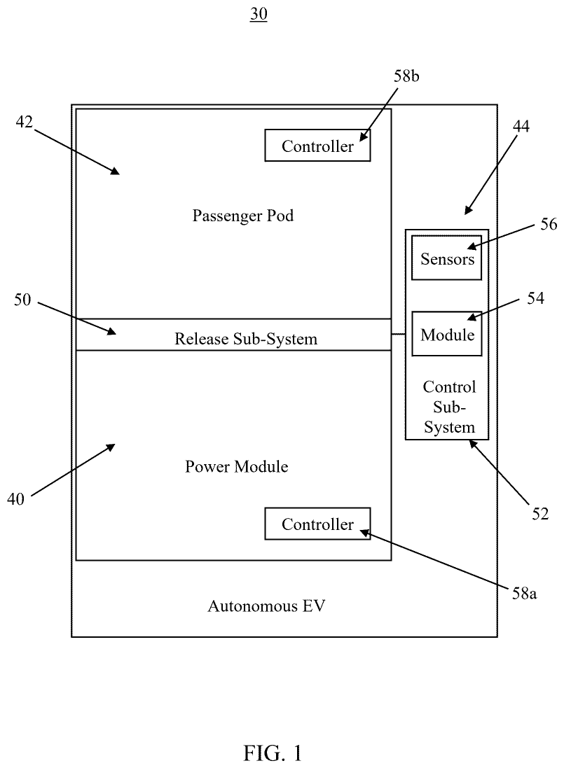

Aspects of the present disclosure address one or more of the above needs, desires and requirements. As a point of reference, and as otherwise provided in the Carroll '474 Patent, one non-limiting example of an AV 30 in accordance with principles of the present disclosure is shown in block form in FIG. 1. The AV 30 includes a power platform (or “power module”) 40, a passenger pod or body (or “pod module”) 42, and an exit/exchange system 44 (referenced generally). The exit/exchange system 44 includes a release sub-system 50 and a control sub-system 52. The release sub-system 50 includes one or more mechanical connection units that connect the power module 40 to the passenger pod 42 in a manner facilitating a robust attachment under normal operating conditions, as well as selectively releasing the power module 40 and the passenger pod 42 relative to one another when prompted by a control module 54 of the control sub-system 52. The AV 30 further includes one or more operational controllers as conventionally employed with an AV that control normal operations of the AV 30. The control module 54 can be incorporated into the operational controller(s) (e.g., software or programming operated by a processor of the operational controller). In other embodiments, the control sub-system 52 can include a dedicated computer or computer-like device separate from the operational controller(s) and operating the control module 54 otherwise programmed (e.g., logic, machine readable instructions, software, etc.) to perform the various safety-related and/or exchange features or instructions described elsewhere. In yet other embodiments, the control module 54 is operated (e.g., programmed to) by a computer entirely apart from the AV 30; with these and related embodiments, the control module 54 is in wired or wireless communication with one or more operation controllers carried by the AV 30 to wired or wirelessly implement a determined safety plan and/or effect one or more steps of a passenger pod exchange operation (e.g., removing a current passenger pod 42 from the power module 40 for storage, loading and securing a new passenger pod 42 to the power module 40, etc.). The control module 54 can, in some embodiments, consider or monitor data from various sources in determining a safety plan for a particular set of circumstances associated with an imminent or unavoidable collision event. In this regard, the data can come from sensors provided with a conventional AV design. In other embodiments, the control sub-system 52 optionally includes one or more additional sensors 56. Further, one or more dedicated controllers 58a can optionally be provided with the power module 40 and/or one or more dedicated controllers 58b can optionally be provided with the passenger pod 42.

The power module 40 can be, or can be akin to, power modules or platforms associated with known or existing AVs or power modules developed in the future. Thus, the power module 40 can include at least the requisite battery, wheels, motors and steering mechanism as known in the art for operation of an AV. In other embodiments, the power module 110 can include one or more additional components not typically utilized or provided with a conventional EV platform as described below. Similarly, in many respects the passenger pod 42 can be, or can be akin to, a passenger pod associated with known or existing AVs or passenger pods developed in the future. Thus, the passenger pod 42 can include at least an outer housing defining a compartment or other enclosed area for passengers, cargo, etc., along with door(s), window(s), etc., for accessing the enclosed area.

The exit/exchange system 44, including the release sub-system 50 and the control sub-system 52, can assume various forms and incorporate various features as described in greater detail below. In general terms, the connectors or fasteners or mechanisms (or mechanical connection units) of the release sub-system 50 attach the power module 40 to the passenger pod 42 and are remotely controlled by the control sub-system 52 to perform the act of purposely timing and directing separation of the passenger pod 42 from the power module 40. The release sub-system 50 can optionally provide two or more points of connection or attachment between the passenger pod 42 and the power module 40. Some purposes are to improve the safety outcome for passengers (or cargo) within or carried by the passenger pod 42 at least one of, optionally all of, before, during and after the event of an unavoidable collision.

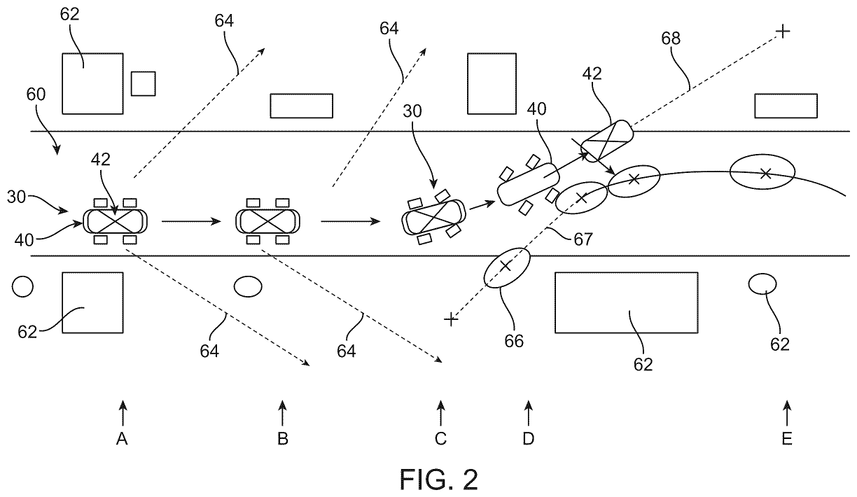

By way of non-limiting example, FIG. 2A illustrates, in simplified form, sequential operation of the exit/exchange system 44 (FIG. 1) in the event of an unavoidable collision and a determination made that the safest outcome is a full exit of the passenger pod 42 from the power module 40. As the AV 30 is traveling along a road 60 with various road-side obstructions 62 (buildings, signs, lights, etc.). A point in time A, the AV 30 is traveling along the road 60 under normal operating conditions in a relatively straight-line path (left-to-right relative to the orientation of FIG. 2), for example as would a conventional AV, with the power module 40 attached to the passenger pod 42. Various sensor information and surrounding data is continuously being reviewed by the control sub-system 52 (FIG. 1). As reflected by dashed arrows 64, the control module 54 (FIG. 1) optionally operates to continuously determine possible safety travel paths otherwise avoiding the obstructions 62. This normal mode of operation continues at point in time B. At point in time C, an imminent or unavoidable collision event of the AV 30 with an object 66 (e.g., a vehicle determined to be entering onto the road 60; an obstacle/body accidently left on the road 60; etc.) is determined or estimated as being highly likely. The determination or estimation of an unavoidable collision event can be made by the logic/programming associated with the control module 54 and/or by logic/programming conventionally provided with some AVs. Regardless, upon determining that an unavoidable collision with the object 66 will occur, the control module 54 determines a safety or safest path (e.g., designated by dashed line 68 in FIG. 2A) for the passenger pod 42 that avoids, to the extent possible, any road-side obstructions 62 and the object 66, and then operates the release sub-system 50 (FIG. 1) to release the passenger pod 42 from the platform 40 at a point in time D that is determined to “send” the passenger pod 42 along the safety path 68. It will be understood that immediately prior to release, the passenger pod 42 is traveling with the power module 40; thus, when released, the passenger pod 42 has momentum in a direction of the platform 40 at the time of release. Further, the AV 30 may be operated/controlled so as to minimize the likelihood of a direct collision with the object 66. These factors can be accounted for by the safety control module 54 (e.g., turning the power module 40 from the straight-line path between point in time C and point in time D). Once released, the passenger pod 42 travels long the safety path 68 and comes to rest at point in time E at a location free of any road-side obstacles 62. The power module 40 may be caused to take other evasive actions relative to the object 66. Regardless, passengers and/or cargo being transported by the passenger pod 42 are safely removed from the hazards of the collision with the object 66.

In other scenarios, systems and methods of the present disclosure may determine that the safest outcome for a determined imminent collision is to perform a partial exit operation. As explained in greater detail below, a partial exit operation entails partially releasing the passenger pod 42 from the power module 40. The passenger pod 42 is then cause to move rearwardly relative to the power module 40 while still remaining partially connected (and thus not fully removed from the power module as with the non-limiting example of FIG. 2). A space between the passenger pod 42 and a front of the power module 40 is created, and a safety airbag can then be inflated in the space. When impact later occurs resulting in the passenger pod 42 being thrust forwardly relative to the power module 40 (or vice-versa), the inflated safety airbag absorbs collision forces between the passenger pod 42 and the power module 40.

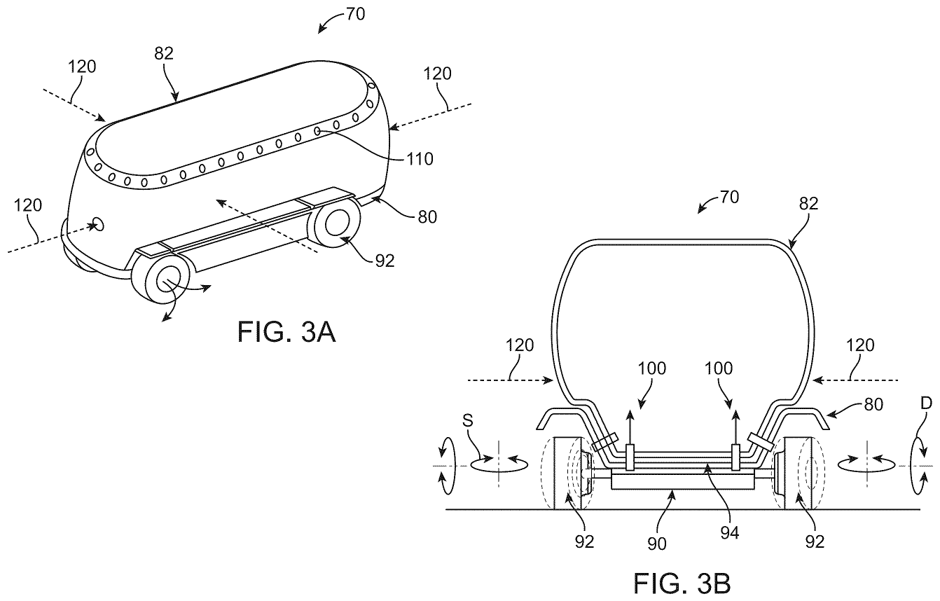

Some non-limiting examples of the exit/exchange system 44, and in particular the control module 54 of the control sub-system 52, in effecting a pre-planned exit implementation process are further explained with reference to FIGS. 3A and 3B in which an AV 70 in accordance with principles of the present disclosure is illustrated. The AV 70 includes a power module 80 and a passenger pod 82 commensurate with the descriptions above. The power module 80 includes, amongst other components, a base 90 and various wheel assemblies. For example, FIG. 3B illustrates two wheels 92 linked to an axle 94 that in turn is connected to the base 90. Additional wheels 92 are shown in FIG. 3A. The wheels 92 are mounted so as to be rotatable relative to the base 90, and thus relative to the passenger pod 82, about a corresponding drive axis (labeled as D in FIG. 3B). Further, the wheels 92 can pivot or rotate about a corresponding turning or steering axis S (labeled as S in FIG. 3B). A steering mechanism (not shown) of a type known in the art can be connected or linked to one or more or all of the wheels 92 to effect desired steering or turning (e.g., in some embodiments, some of the wheels 92 can be positively or actively steered, while others of the wheels 92 more passively follow an effected turn). Regardless, the passenger pod 82 is connected to the power module 80 by components or mechanical connection units of a release sub-system 100 as generally reflected in FIG. 3B. Though not specifically identified in the views, a control sub-system commensurate with the descriptions of the present disclosure is further provided, and operates (e.g., a safety control module of the control sub-system is programmed) to prompt operation of the release sub-system 100 to disconnect the passenger pod 82 from the power module 80, for example under circumstances of an imminent or unavoidable collision, a desired passenger pod exchange, etc.

In some optional embodiments, and as reflected by FIG. 3A, the AV 70 can incorporate sensors 110 along the passenger pod 82. Information from the sensors 110 can be utilized by the control sub-system (not shown) in determining a best exit path or safety path for the passenger pod 82 in the event of an imminent or unavoidable collision, directionality for a passenger pod exchange operation, etc. In some embodiments, the sensors 110 can be of a type and location conventionally employed with AVs. In other embodiments, the sensors 110 can be configured and/or located intentionally for the safety methods of the present disclosure, and thus can be considered components of the control sub-system. Further, data from additional sensors (not shown), either on or apart from the AV 70, and/or other sources can be employed as part of the safety path determination algorithms, passenger pod exchanger operations, etc., of the present disclosure.

In the views of FIGS. 3A and 3B, dark lined, dashed arrows 120 represent but a few possible unavoidable forces that could act upon the AV 70 with a collision. Upon determining that a collision is imminent or unavoidable and the likely force(s) 120 that will be placed upon the AV 70 when the collision occurs, the control sub-system (and in particular the logic or algorithms acted upon or implemented by a safety control module of the control sub-system) determines a desired safety path for the passenger pod 82, and then implements various operational steps to implement the desired safety path. For example, one or more or all of the wheels 92 are caused to turn (about the corresponding steering axis) and/or are driven about the corresponding drive axis D. The release sub-system is prompted to release the passenger pod 82 from the power module 80, sacrificing power and inertia of the power module 80. The passenger pod 82 escapes from part of the force of impact of the imminent collision to scrub off energy over time and surfaces, thus improving a safety outcome for passengers in the passenger pod 82. The escape path of the passenger pod 82 can be in a direction opposite a current direction of travel of the AV 70 should a forward safety path be unavailable or less safe; for example, wheel friction on the passenger pod 82 can be used to send the passenger pod 82 in a direction away from the impending impact.

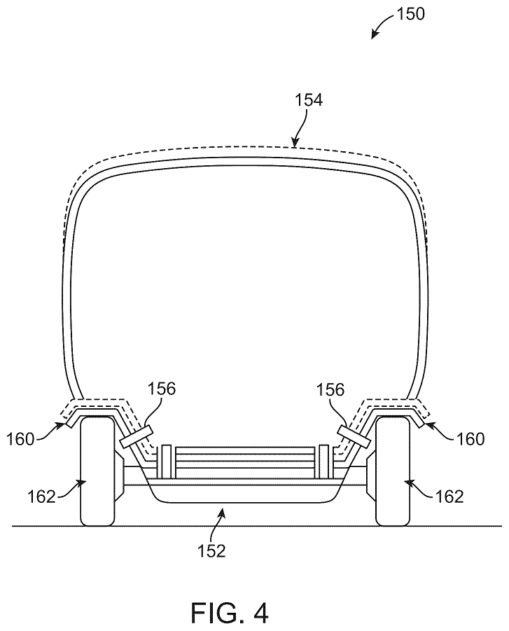

Some aspects of the present disclosure are directed to systems and methods for effecting contact between one or more of the driven wheels 90 with a surface of a released passenger pod 82 as part of an exit operation and/or a passenger pod exchange operation. By way of further reference, FIG. 4 illustrate portions of another AV 150 in accordance with principles of the present disclosure. The AV 150 includes a power module 152 and a passenger pod 154 that can assume any of the formats of the present disclosure. One or more mechanical connection units 156 (generally shown) attach the passenger pod 154 to the power module 152 during normal operation of the AV 150, and are operable to disconnect or release the passenger pod 154 from the power module 152 (at the corresponding point of connection) as described above.

The AV 150 includes or incorporates one or more features that facilitate raising a portion of the power module 152 relative to the passenger pod 154 relative or vice-versa, for example when prompted by a control module. As a point of reference, a vertical position of the passenger pod 154 relative to the power module 152 under normal operating conditions (e.g., a “drive arrangement” of the passenger pod 154 relative to the power module 152) is shown with dashed lines in FIG. 4; solid lines represent an “escape arrangement” or “exchange arrangement” of the passenger pod 154 relative to the power module 152. The passenger pod 154 can include or define surface features (e.g., pads or fenders) 160 that are each vertically aligned with a corresponding one of the wheels 162 provided with the power module 152. In the escape or exchange arrangement, one or both of the wheels 162 come into contact with the surface feature 160 (or vice-versa). Under circumstances where the contacted wheel 162 is driven or spinning, then, the wheel 162 exerts a force onto the surface feature 160, and thus the passenger pod 154, via frictional interface. A contact surface of the surface feature 160 can be formed of a material exhibiting an enhanced co-efficient of friction with a material/surface of the wheels 162 so as to enhance frictional contact at the surface feature 160/wheel 162 interface. Regardless, contact with the wheels 162 moves the passenger pod 154 relative to the power module 152. A direction of the applied force can be dictated by the control module, for example by, where appropriate, reversing polarity of one or more of the wheel motors as mentioned above. It is noted that in some applications, the action of reversing the motor by switching the polarity is quickly accomplished, applying the traction for the wheels/tires 162 to the road away from a forward collision event to lower the inertia at impact for the AV 150 in general. In some motors, the AV may use brakes to best effect reversal of the polarity. In the case of a stationary or reversing motion of the AV 150, this use of the motor(s) in advance of the collision works as well. In some exit operational modes, the contact of the wheel(s)/tire(s) 162 upon the passenger pod 154 can send the passenger pod 154 away from the collision on a safer path for the occupants. In other exit operational modes, the passenger pod 154 is initially released relative to the power platform 152 to slide away from a potential impact, but subsequently remains connected to the power platform 152. In an exchange operational mode, contact between the driven wheel(s) 162 and the passenger pod 154 can move the passenger pod 154 onto or away from the power platform 152 in a controlled manner as described below.

From the above explanations, the inventor of the present disclosure has recognized a desire to facilitate enhanced contact between the passenger pod and one or more driven wheels of the power module for example while that same driven wheel(s) is not in contact with the ground as part of an exit operation or an exchange operation. In some embodiments of the present disclosure, one or more wheel indexing features are provided (e.g., vertical indexing, inward indexing, outward indexing, camber indexing, etc.) that promote desired contact with the passenger pod. The inventor of the present disclosure has also recognized a desire to enhance passenger pod exchange operations, including, but not limited to, reducing time and complexity for completing removal of a passenger pod from the power module or loading/docking of a new passenger pod, and simplified storage of a removed passenger pod. The inventor of the present disclosure has also recognized a desire to provide a partial exit operation responsive to a determined imminent collision in which the passenger pod is partially released from the power module and additional safety features are deployed. AV's of the present disclosure address one or more or all of these desired improvements.

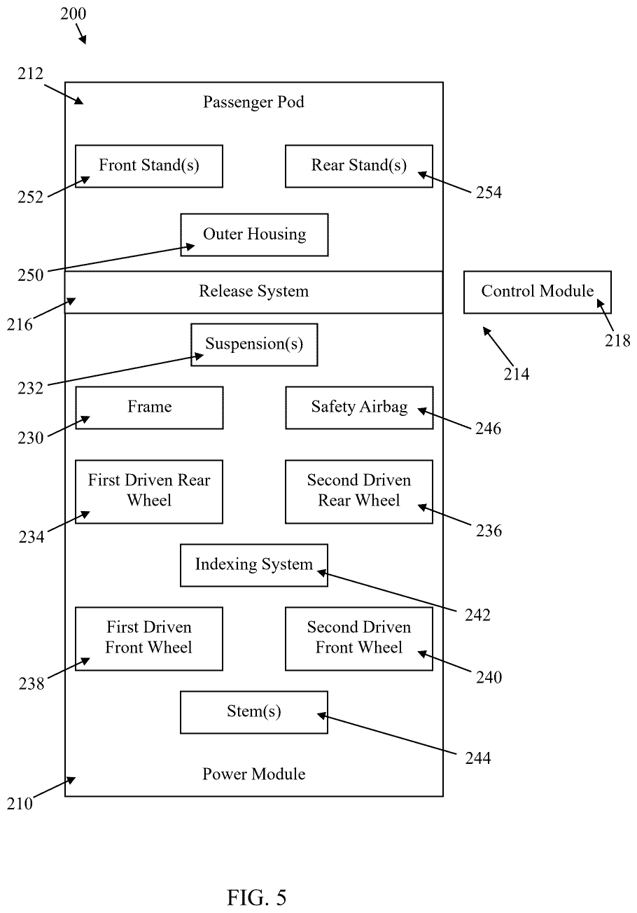

With the above in mind, portions of one embodiment of an AV 200 in accordance with principles of the present are shown in block form in FIG. 5. The AV 200 can be incorporate features of any of the AV's of the present disclosure and includes a power module (or power platform) 210, a passenger pod (or pod module) 212, and an exit/exchange system 214 (referenced generally). The exit/exchange system 214 includes a release sub-system 216 and a control module 218. The release sub-system 216 includes one or more mechanical connection units that connect the power module 210 to the passenger pod 212 in a manner facilitating a robust attachment under normal operating conditions, as well as selectively releasing the power module 210 and the passenger pod 212 relative to one another when prompted by a control module 218.

The power module 210 can be, or can be akin to, power modules or platforms associated with known or existing AVs or power modules developed in the future. Thus, the power module 210 can include a frame or chassis 230 supporting at least the requisite battery, steering mechanisms, sensors, controllers, etc., as known in the art for operation of an AV. The power module 210 further includes one or more suspension systems 232, first and second driven front wheel assemblies 234, 236, first and second driven rear wheel assemblies 238, 240, one or more indexing systems 242, one or more stems 244, and one or more safety airbags 246. The suspension system 232 is disposed between the passenger pod 212 and the frame 230, serving to reduce or attenuate transmission of shocks, road vibrations, and other disturbances at the power module 210 to the passenger pod 212. In some embodiments, the suspension system 232 can include an airbag or elastomeric bladder provided at one or more or all of the wheel assemblies 234-240. The wheel assemblies 234-240 can each include a wheel or tire and a motor that operates to rotate the corresponding wheel or tire. The indexing system 242 is provided for at least one of the wheel assemblies 234-240 (e.g., an indexing system 242 is provided for each of the first and second driven rear wheel assemblies 238, 240) and is operable to prompt movement of the corresponding wheel in one or more of a vertical or horizontal direction. The stem(s) 244 are carried by the frame 230 and are operable to support the frame relative to ground in a deployed state. Finally, the safety airbag(s) 246 is located between the frame 230 and the passenger pod 212 and can be deployed (e.g., inflated) as part of partial exit operation as described below. In other embodiments, the power module 210 can include one or more additional components not typically utilized or provided with a conventional EV platform.

In many respects the passenger pod 212 can be, or can be akin to, a passenger pod associated with known or existing AVs or passenger pods developed in the future. Thus, the passenger pod 212 can include at least an outer housing 250 defining a compartment or other enclosed area for passengers, cargo, etc., along with door(s), window(s), etc. for accessing the enclosed area. In addition to other components or controllers provided with an AV passenger pod, the passenger pod 212 includes one or more front stands 252 and or more rear stands 254. The stands 252, 254 are deployable relative to an exterior of the outer housing 250 and are operable to support the passenger pod 212 relative to ground when the passenger pod 212 is removed from the power module 210 following an exchange operation as described below.

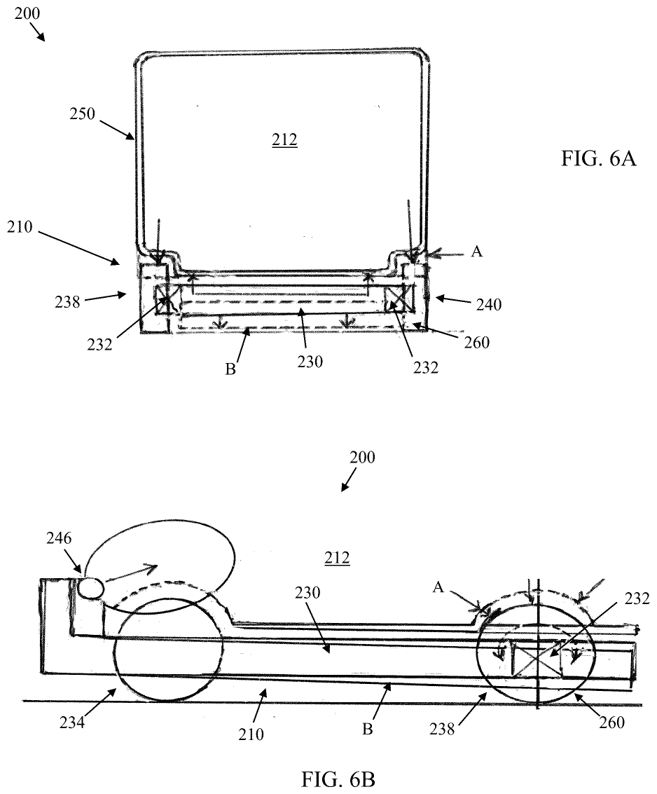

Various, non-limiting examples of the various components of the AV 200 are provided below. In more general terms, and with additional reference to FIGS. 6A and 6B, during normal driving operations, the passenger pod 212 is supported relative to the frame 230 of the power module 210 by the suspension systems 232 (it being understood that in the view of FIG. 6A, a suspension system 232 is provided at each of the two rear driven wheel assemblies 238, 240. The suspension assemblies 232 are operable to lower the outer housing 250 of the passenger pod 212 into contact with a tire 260 of the wheel assemblies 234-240, raise the tire 260 of the corresponding wheel assembly 238, 240 into contact with the outer housing 250 (indicated at “A” in FIGS. 6A and 6B), and/or to lower the frame 230 relative to the corresponding tire 260 (indicated at “B” in FIGS. 6A and 6B). As part of an exit operation, the release sub-system 216 (identified generally in FIG. 6A) operates to release the passenger pod 212 relative to the power module 210. The suspension assemblies 232 operate to bring the outer housing 250 into contact with one or more of the tires 260, with the so-contacted tire(s) 260 being driven in a determined direction. The suspension assemblies 232 can further be operated to lower the frame 230 relative to the tires 260 of at least the rear driven wheel assemblies 238, 240 to provide clearance for movement of the passenger pod 212 relative to the power module 210. An exit operation can further include inflating the safety airbag 246 after the passenger pod 212 has been caused to move a short distance rearwardly relative to the power module 210 (e.g., rightward relative to the orientation of FIG. 6B) thus creating a gap between the frame 230 and the outer housing 230, with the inflated safety airbag 246 serving as a force absorbing cushion between the frame 230 and the outer housing 250 in the event of a collision.

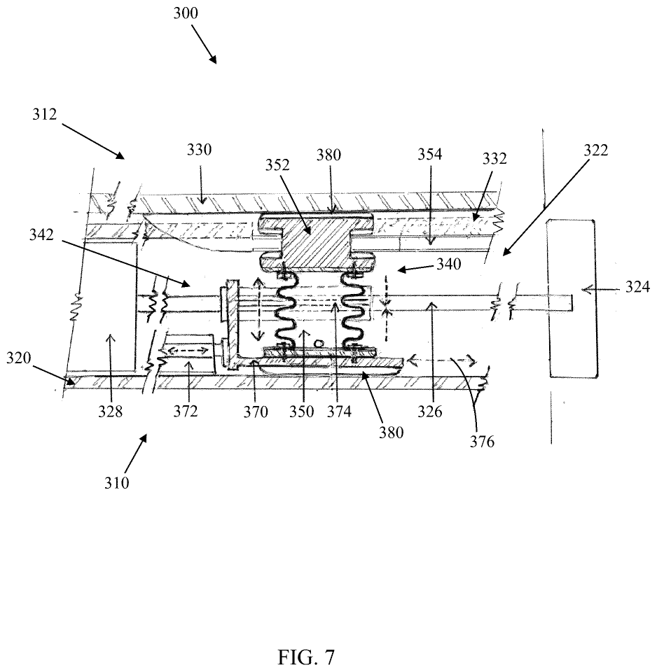

The indexing systems 242 of the present disclosure can assume various forms and in some examples are configured in tandem portions of the capture and release mechanisms and/or the suspension assemblies 232. For example, FIG. 7 is a simplified cross-sectional view of portions of an AV 300 in accordance with principle of the present disclosure. The AV 300 includes a power module 310 and a passenger pod 312. The power module 310 can generally have any of the configurations of the present disclosure and includes a frame or chassis 320 supporting a number of wheel assemblies, one of which is shown in FIG. 7 at 322. The wheel assembly 322 can assume various forms and in some embodiments includes a tire or wheel 324, a drive shaft 326 and a motor 328 (e.g., a nested internal motor, an in-wheel motor, etc.). The passenger pod 312 can generally have any of the configurations of the present disclosure and includes an outer housing 330 that has or defines a floor region 332.

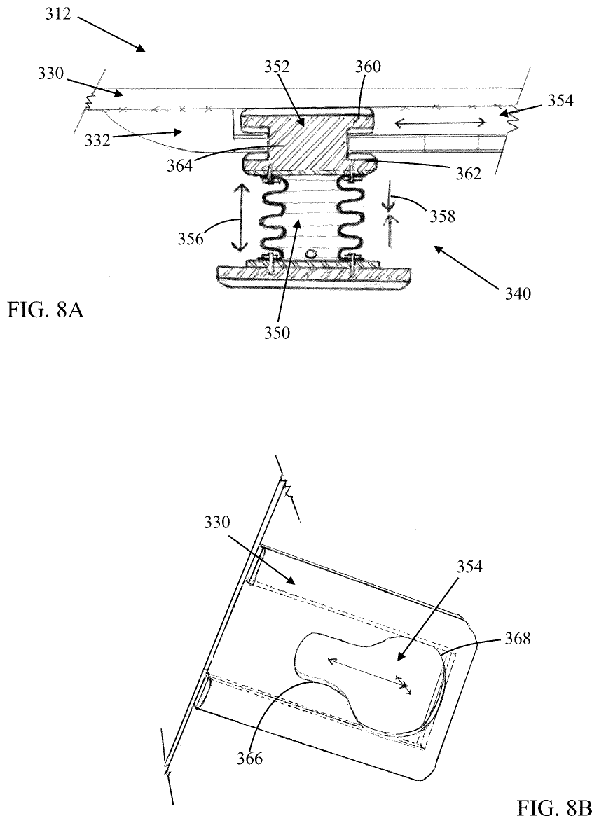

The AV 300 further includes a capture and release assembly 340 and an indexing system 342. With the non-limiting example of FIG. 7, the capture and release assembly 340 includes a pod suspension airbag 350, a collar 352, and a retention slot 354. The pod suspension airbag 350 is attached to the collar 352 and is connected to the frame 320 by components of the indexing system 342 as described in greater detail below. The collar 352 has a spool-like shape and is configured to be selectively captured within the retention slot 354. With additional reference to FIG. 8A (that otherwise shows portions of the passenger pod 312 and the capture and release assembly 340 in isolation for ease of understanding), the pod suspension airbag 350 can expand or contract with inflation and deflation (as represented by arrows 356, 358). The collar 352 includes opposing flanges 360, 362 that extend radially outward relative to a central section 364. The retention slot 354 is formed or defined by the outer housing 330 (e.g., along the floor region 332). With additional reference to FIG. 8B, the retention slot 354 defines a capture zone 366 and a release zone 368. A size of the capture zone 366 generally corresponds with a diameter or outer dimension of the central section 364. When the collar 352 is arranged in or aligned with the capture zone 366, then, a structure of the outer housing 330 is captured between the flanges 360, 362 to define a captured state. A size of the release zone 368 is slightly greater than a diameter or outer dimension of the flanges 360, 362, When the collar 352 is arranged in or aligned with the release zone 368, the collar 352 is free of or released from the structure of the outer housing 330 to define a released state. In other embodiments, the capture/release collar-to-pod slot arrangement can have an inward format to nest the retention slot 354 in a fluish manner into the floor region 322 (FIG. 7) of the passenger pod 312. With these and related embodiments, a substantive protrusion on surface(s) of the floor region 322 to provide enhanced exit clearance during partial or full release operations while also promoting a more uniform slide-to-a-stop interface with the ground after the passenger pod 312 has been sent from the power module 310 (FIG. 7). In yet other embodiments, the retention slot 354 can be formatted to arrange the capture zone 366 and the release zone 366 in a reverse direction from that implicated by FIG. 8B, for example to facilitate inward indexing release and inside direction of wheel-to-passenger pod contact.

With specific reference to FIG. 7 (that otherwise represents a captured state in which the collar 352 is aligned with capture zone 366 (FIG. 8B)), in some embodiments, features of the indexing system 342 are operable to articulate the pod suspension airbag 350; the collar 352 articulates with movement of the pod suspension airbag 350 to thus transition the capture and release assembly 340 between the capture state and the release state. For example, the indexing system 342 can include a slide member (or drawer) 370, an actuator 372, and a drive shaft extension member 374. The slide member 370 is slidably supported on a surface of the frame 320, and is connected to the pod suspension airbag 350 and the drive shaft extension member 374. The actuator 372 (e.g., linear actuator) includes a piston that is attached to the slide member 370, and operates to move the piston, and thus the slide member 370, in directions identified by arrow 376. Various sensors (not shown) can optionally be provided that validate correct and timely motion of the piston as part of partial exit operation, full exit operation, and/or escape operation.

In a normal or driving mode of operation of the AV 300, the capture and release assembly 340 and the indexing system 342 are in the arrangement of FIG. 7, including the passenger pod 312 coupled to the power module 310 at the captured interface of the collar 352 to the outer housing 330 (it being understood that a number of additional couplings can be established by other capture and release mechanisms provided with the AV 300). The pod suspension airbag 350 is inflated such that the collar 352 robustly bears upwardly against a horizontal surface of the outer housing 330. In this state, the pod suspension airbag 350 serves to reduce or attenuate transmission of shocks, road vibrations, and other disturbances at the power module 310 to the passenger pod 312. The capture and release assembly 340 can be transitioned to the released state by partially deflating or venting the pod suspension airbag 350, thus causing (or allowing) the collar 352 to move slightly away from the robust, upwardly bearing contact with the horizontal surface of the outer housing 330. The actuator 372 then operates to move the slide member 370, and thus the pod suspension airbag 350, relative to the frame 320 (rightward relative to the orientation of FIG. 7). Because the collar 352 is not in load bearing engagement with the outer housing 330, the collar 352 readily slides with sliding movement of the pod suspension airbag 350. Optionally, one or more low friction pads 380 (e.g., UHMW pads) can be provided at the various interfaces to further promote sliding. Regardless, the collar 352 is caused to move to the released state relative to the retention slot 354. Once in a position of the released state, the pod suspension airbag 350 can be further deflated or vented, moving the collar 352 vertically away from the passenger pod 312 (downwardly relative to the orientation of FIG. 7), thus fully removing the collar 352 from connection to the passenger pod 312. As a result, at least at a location of the capture and release assembly 340, the passenger pod 312 is released from the power module 310. As a point of reference, these steps can be performed in reverse order to couple a passenger pod 312 to the power module 310 for reasons made clear below. Regardless, movement of the slide member 370 is also imparted onto the drive shaft extension member 374. The drive shaft extension member 374 is provided as part of the drive shaft 326, and functions to increase or decrease a length of the drive shaft 326. Thus, linear movement of the drive shaft extension member 374 changes or indexes a horizontal location of the wheel 324 relative to the frame 320, and thus relative to the passenger pod 312. Indexed movement of the wheel 324 can, for example, move the wheel 324 to a desired location for contact with the released passenger pod 312 and/or to a desired location where the wheel 324 is clear of contact with the passenger pod 312 for reasons made clear below.

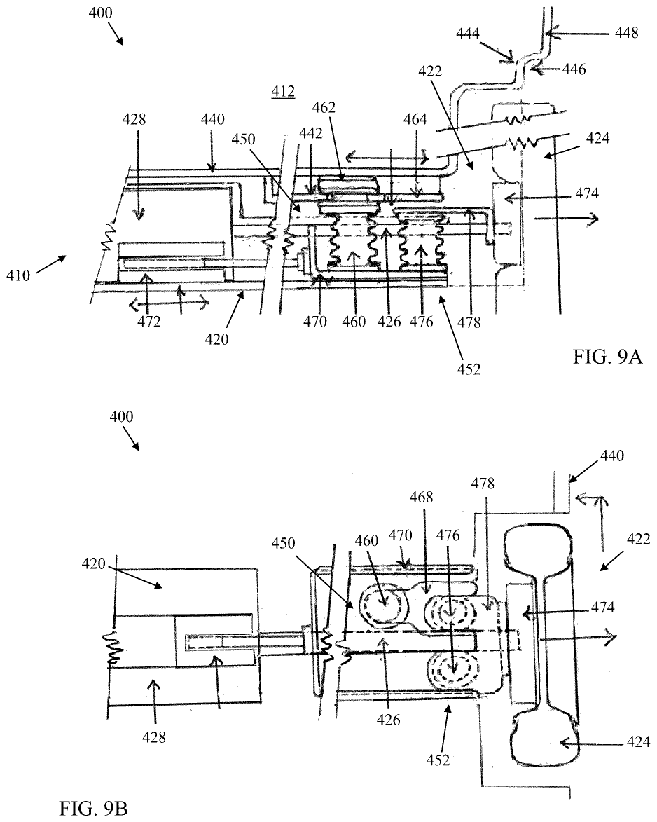

Portions of another AV 400 in accordance with principle of the present disclosure and providing wheel indexing features are shown in FIGS. 9A and 9B. The AV 400 includes a power module 410 and a passenger pod 412. The power module 410 can generally have any of the configurations of the present disclosure and includes a frame or chassis 420 supporting a number of wheel assemblies, one of which is shown in FIGS. 9A and 9B at 422. The wheel assembly 422 can assume various forms and in some embodiments includes a tire or wheel 424, a drive shaft 426, and a motor 428. The passenger pod 412 can generally have any of the configurations of the present disclosure and includes an outer housing 440 that has or defines a floor region 442 and wheel well region 444 with one or more optional tire riding surfaces 446, 448.

The AV 400 further includes a capture and release assembly 450 and an indexing system 452. With the non-limiting example of FIGS. 9A and 9B, the capture and release assembly 450 includes a pod suspension airbag 460, a collar 462, and a retention slot 464 that can otherwise be similar to the pod suspension airbag 350, collar 352 and retention slot 354 (FIG. 7) described above, with the capture and release assembly 450 being configured to be transitioned between a captured state and a release state (e.g., by bringing the collar 462 into alignment with a release zone 468 of the retention slot 464).

The indexing system 452 can include a slide member (or drawer) 470, an actuator 472, a planetary gear or in-wheel motor 474, one or more wheel suspension airbags 476, and a coupler 478. The slide member 470 member is similar to the slide member 370 (FIG. 7) described above and is slidably supported on a surface of the frame 420. Further, the slide member 470 is connected to and supports the pod suspension airbag 460 and the wheel suspension airbags 476. The actuator 472 (e.g., linear actuator) includes a piston that is attached to the slide member 470, and operates to move the piston, and thus the slide member 470, as described above, for example with reference to a linear actuator programmable distance feature 478. The amount and timing of the indexing can be controlled by a control module or computing device (e.g., the control module 218 (FIG. 5)) to promote active and timely procedures. The wheel suspension airbags 476 are attached to the coupler 478 opposite the slide member 470. The coupler 478 is further connected to the wheel 424, for example via the planetary gear or in-wheel motor 474 and/or splined connection with the drive shaft 426.

In a normal or driving mode of operation of the AV 400, the capture and release assembly 450 and the indexing system 452 are in the arrangement of FIGS. 9A and 9B, including the passenger pod 412 coupled to the power module 410 at the captured interface of the collar 462 to the outer housing 440 (it being understood that a number of additional couplings can be established by other capture and release mechanisms provided with the AV 400). The pod suspension airbag 460 is inflated such that the collar 462 robustly bears upwardly against a horizontal surface of the outer housing 440. In this state, the pod suspension airbag 460 serves to reduce or attenuate transmission of shocks, road vibrations, and other disturbances at the power module 410 to the passenger pod 412. The capture and release assembly 450 can be transitioned to the released state by partially deflating or venting the pod suspension airbag 460 and moving the collar 462 to the released state relative to the retention slot 464 via actuator-prompted movement of the slide member 470 as described. Once in a position of the released state, the pod suspension airbag 460 can be further deflated or vented, moving the collar 462 vertically away from the passenger pod 412 (downwardly relative to the orientation of FIG. 9A). As a result, at least at a location of the capture and release assembly 450, the passenger pod 412 is released from the power module 410. As a point of reference, these steps can be performed in reverse order to couple a passenger pod 412 to the power module 410 for reasons made clear below.

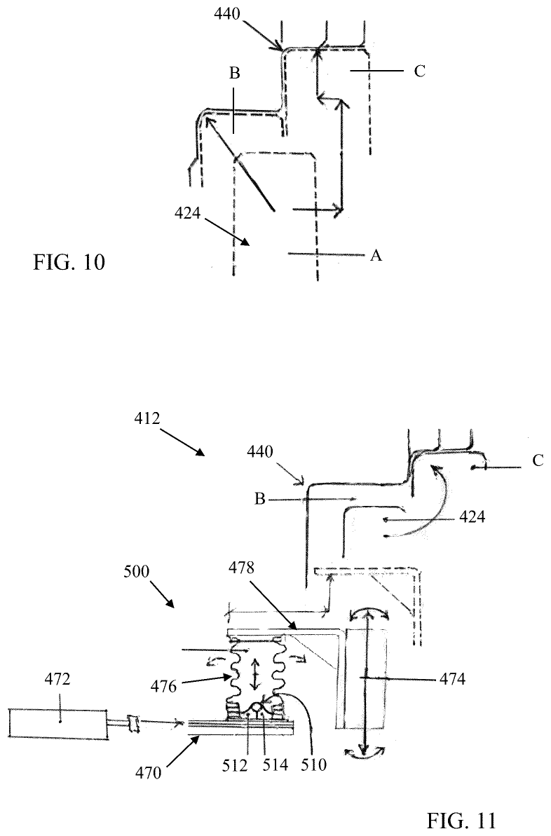

Movement of the slide member 470 is also imparted onto the wheel suspension airbags 476 and thus the coupler 476. In that the coupler 476 is connected to the wheel 424, linear movement of the slide member 470 changes or indexes a horizontal location of the wheel 424 relative to the frame 420, and thus relative to the passenger pod 412 as indicated by arrow 480. Vertical indexing of the wheel 424 relative to the frame 420, and thus relative to the passenger pod 412 (indicated by arrow 482) can be provided by inflating or deflating the wheel suspension airbags 476. Vertical indexed movement of the wheel 424 can, for example, move the wheel 424 to a desired location for contact with one of the optional tire riding surfaces 446, 448. By way of non-limiting example, FIG. 10 schematically reflects indexed movement of the wheel 424 from a normal driving position (labeled “A”) to various contact positions with the passenger pod outer housing 440, labeled at “B” and “C”. Notably, FIG. 10 reflects that the outer housing 440 can have variations along an outer surface thereof that can contact the wheel 424 in position C.

In yet other embodiments, indexing systems of the present disclosure can provide for camber adjustment of the corresponding wheel. For example, FIG. 11 is a simplified representation of portions of an indexing system 500. The indexing system 500 can be similar to the indexing system 452 (FIGS. 9A and 9B) described above, and generally includes the slide member 470, the actuator 472, the planetary gear or in-wheel motor 474, one or more wheel suspension airbags 476, and the coupler 478. In addition, a divider or pivot 510 is associated with the wheel suspension airbag 476. An adjustable air valve (not shown) directs more or less air to one side or the other of the divider/pivot 510 at air pockets 512, 514. This filling action causes the wheel suspension airbag 476, and thus the coupler 478 to tilt when a change in a camber of the wheel 424 (via connection to the planetary gear or in-wheel motor 474) is desired. This can be used in a number of ways to support the index to contact system. It can tilt differently based on the action of the wheel 424 in motion, adjust based on weight of the passenger pod 412, adjust for stopping wheel vibrations based on road conditions, adjust for angle based on road shape or ground slope, adjust to put pressure on the wheel/tire side for contact with the released passenger pod 412 (generally indicated at “B” and “C” in FIG. 11). The angle or camber adjustment cause by air pressure differences on either side of the divider 510 can be accomplished by pulsing the amount of change at the air pockets 512, 514.

Returning to FIG. 5, any of the indexing systems 242 of the present disclosure can be useful in performing various operational modes, for example in performing an exit operation in which the passenger pod 212 is fully released and sent away from the power module 210, a partial exit operation in which the passenger pod 212 is released by not fully removed from the power module 210, and/or an exchange operation in which the passenger pod 212 is released from the power module 210 and transitioned to a storage state away from the power module 210 (“drop-off phase” of an exchange operation) or a stored passenger pod 212 is loaded and docked to the power module 210 (“pick-up phase” of an exchange operation). With respect to the exchange operation, AV's of the present disclosure can optionally include one or more additional features that facilitate one or more of these operational modes, such as the stem(s) 244 provided with the power module 210 and/or the stands 252, 254 provided with the passenger pod 212. As explained in greater detail below, in some examples, loading and docking of the stored passenger pod 212 to the power module 210 uses heights of the stands 252, 254; timing for the smooth sequence with avoidance of overt contact with the power module 210 assists in completing the various setting, loading/picking, and sending procedures. Wireless communication can option be used to coordinate and align the power module 210 with the stored passenger pod 212, it being recognized that snow conditions, ground slopes in all directions, etc., can impact the operation. These and other features can better ensure successful swapping of passenger pods and partial or full exit operations.

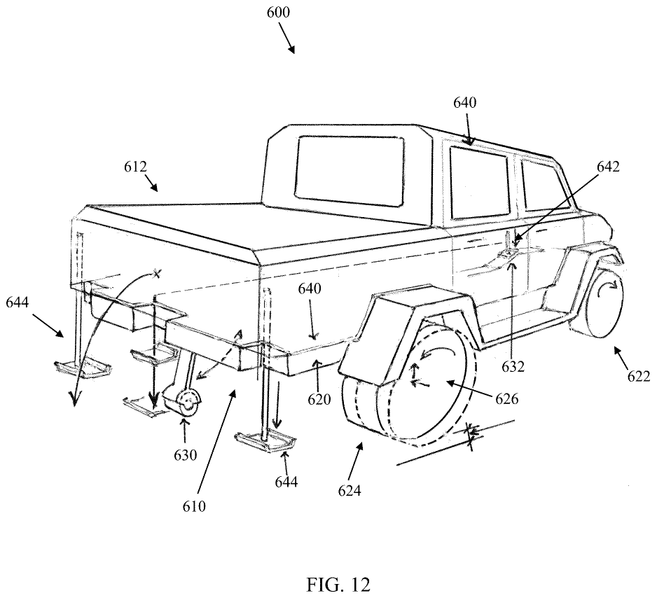

For example, FIG. 12 illustrates another example AV 600 in accordance with principles of the present disclosure. The AV 600 includes a power module 610 and a passenger pod 612. The power module 610 can generally have any of the configurations of the present disclosure and includes a frame or chassis 620 supporting a number of wheel assemblies, including a front wheel assembly 622 and a rear wheel assembly 624 that are visible in the view. The wheel assemblies 622, 624 can assume various forms as described above and each include a driven tire or wheel 626. A stem 630 is carried by the frame 620 and is transitionable between a deployed state (shown in FIG. 12) and a retracted state in which the stem 630 is maintained within a footprint of the frame 620. The frame 620 forms or carries one or more ledges 632 (one of which is illustrated in phantom in FIG. 12) that are configured and arranged to interface with a corresponding feature of the passenger pod 612 as described below.

The passenger pod 612 can generally have any of the configurations of the present disclosure and includes an outer housing 640, one or more front stands 642, and one or more rear stands 644. In some embodiments, at least three of the stands 642, 644 are provided. The stands 642, 644 are each transitionable between a deployed state and a retracted state; in the view of the FIG. 12, the front stand 642 is shown in the retracted state, and the rear stands 644 are shown in the deployed state. As a point of reference, while a style or format of the outer housing 640 of FIG. 12 generally implicates a conventional pickup truck, other formats are equally acceptable (e.g., similar to a conventional van, wagon, RV, etc.).

Though hidden in the view, the AV 600 further includes one or more capture and release mechanisms that can have any of the formats of the present disclosure and operate to selectively capture and release the passenger pod 612 relative to the power module 610. Further, one or more indexing systems can be provided with the AV 600, such as any of the indexing systems described above, for example to effecting indexed movement of the 626 of one or both of the rear wheel assemblies 624 relative to the frame 620 and the passenger pod 612. Regardless, suspension systems (hidden) are provided that support the outer housing 640 relative to the frame 620, and can include one or more pod suspension airbags as described above provided proximate each of the wheel assemblies 622, 624.

As a point of reference, in some of the descriptions below, reference is made to the suspension system(s) operating to lift the wheels 626 of the rear wheel assemblies 624 off of the ground and/or to lower a rear side of the frame 620 closer to the ground. In some embodiments, this can be achieved by controlled filling/venting of the pod suspension airbags as a pneumatic suspension assembly configured to impart a controlled upward displacement of the frame 620 at a rear side thereof. When air pressure inside the pod suspension airbags associated with the rear wheel assemblies 624 increases, the rear of the frame 620 extends upwardly; when pressure is released quickly, the rear of the frame 620 contracts downward. The faster and more aggressive this pressure is cycled, the more dynamic the vertical movement. A mass of the AV 600 and inertia also play a role. When the rear pod suspension airbags “kick upward” quickly, the rear of the frame 620 continues traveling up for a moment even after the airbag stops pushing. If nothing restricts upward travel, the wheel 626 of the rear wheel assemblies 624 will lose contact with the ground. When the pod suspension airbags of the rear wheel assemblies 624 are rapidly vented, the rear side of the frame 620 will drop downward under gravity. With pressure regulators and valves in place, large bursts of energy can be delivered at the rear side of the frame 620.

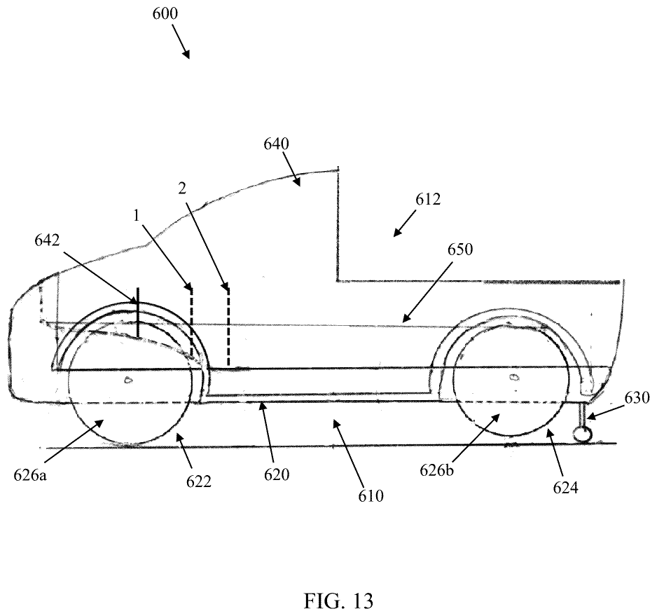

With the above in mind, some exchange operations of the present disclosure can be described with additional reference to FIG. 13. As a point of reference, FIG. 13 is a simplified side view illustration of the AV 600 at stage of the drop-off phase of an exchange operation in which the passenger pod 612 will be removed from the power module 610 for storage. Prior to the stage of FIG. 13, the AV 600 can be in a normal driving operational mode in which the passenger pod 612 is coupled to the power module 610, the stem(s) 630 is in the retracted stated (nested within a footprint of the frame 620) and the stands 642, 644 are in the retracted state (nested within a footprint of the outer housing 640). When it is determined that the drop-off phase of the exchange operational mode is to be performed (e.g., in response to a user request or prompt) and that the AV 600 is location where removal of the passenger pod 612 from the power module 610 is appropriate (e.g., based on a review of the surrounding environment as implicated by various sensor data), the pod suspension airbags of the rear wheel assemblies 624 are rapidly inflated and deflated. As described above, this action causes the rear side of the frame 620 to raise off the ground, as does the wheel 626 of each of the rear wheel assemblies 624. For ease of explanation, the wheel of the front wheel assembly 622 visible in FIG. 13 is labeled as 626a (“front wheel”) and the wheel of the rear wheel assemblies 624 visible in FIG. 13 is labeled as 626b (“rear wheel”). At a point in time where the vertically upward movement of the rear side of the frame 620 is sufficient, the stem 630 is actuated to the deployed state shown in FIG. 13 in which the stem 630 is in contact with the ground. In this arrangement, then, the deployed stem 630 holds the rear side of frame 620 in the vertically raised position, with the rear wheels 626b maintained above, and not in contact with, the ground.

With the rear wheels 626b free of contact with the ground, capture and release mechanism(s) (hidden) are operated to release the passenger pod 612 relative to the power module 610. This action, in turn, brings a surface 650 (e.g., a ledge) of the outer housing 640 into contact with the rear wheels 626b. Alternatively or in addition, indexing system(s) optionally provided with each of the rear wheel assemblies 624 can be operated to bring the rear wheels 626b into contact with the outer housing 640 as described above. Regardless, with the rear wheels 626b now in contact with the outer housing 640, the rear wheel assemblies 624 are operated to rotate the rear wheels 626b in a direction that causes the passenger pod 612 to move in a rearward direction relative to the power module 610 (e.g., relative to the orientation of FIG. 13, the rear wheel 626b visible in the view is rotated clockwise that in turn causes the passenger pod 612 to move in a rightward direction). During this operation, the front wheel assemblies 624 can be operated to hold the front wheels 626a stationary via, for example, an applied braking force.

With continued rearward movement of the passenger pod 612 relative to the power module 610, the rear stands 644 become spatially arranged rearwardly away from the power module 610 (e.g., the approximate arrangement of FIG. 12). With the rear stands 644 now clear of the power module 610, the rear stands 644 are actuated to the deployed state and come into contact with the ground as shown. In the deployed state, then, the rear stands 644 support a rear region of the passenger pod 612 relative to the ground. With further driven rearward movement of the passenger pod 612 relative to the power module 612, the deployed rear stands 644 remain in sliding contact with the ground, and can include a slide plate 652 or similar body that promotes a sliding interface.

As generally implicated by FIG. 12, the front stands 642 can also transition toward the deployed state with rearward movement of the passenger pod 612 relative to the power module 610, for example tracking along the corresponding ledge 632. By way of example, an initial location of the front stand 642 is shown with a solid line in FIG. 13. As the passenger pod 612 is caused to move rearwardly relative to the power module 610, the front stand 642 transitions toward the deployed state, sliding along the ledge 632 from the initial location to the locations labeled as “1” and “2” in the view. Once the passenger pod 612 has moved rearwardly relative to the power module 610 to an extent sufficient to spatially arrange the front stands 642 rearwardly away from or clear of the power module 610, the front stands 642 can be actuated to the fully deployed state so as to be in contact with the ground. At this stage of the drop-off phase of the exchange operation, then, the released passenger pod 612 is fully supported relative to the ground by the deployed front and rear stands 642, 644. The power module 610 can then be operated to bring the rear wheels 626b out of contact with the passenger pod 612 and back into contact with the ground (e.g., the stem 630 is transition from the deployed state to the retracted state). The power module 610 can then be operated to move away from the now independently supported passenger pod 612.

To perform a pick-up phase of an exchange operation (in which a stored passenger pod 612, otherwise arranged with the front and rear stands 642, 644 supporting the outer housing 640 relative to ground, is loaded onto and docked to the power module 610), the steps describe above can generally be performed in a reverse order. In some examples, the pick-up phase can include a location comparison between the power module 610 and the to-be-picked-up passenger pod 612 to confirm that the power module 610 is positioned in alignment with the passenger pod 612. The elevated rear wheels 626b can be brought into contact with the outer housing 640 and then driven to move the passenger pod 612 forwardly relative to the power module 610 (e.g., relative to the orientation of FIG. 13, the rear wheels 626b are rotated in a counterclockwise direction). In this regard, the rear wheels 626b remain supported relative to ground via the deployed stem 630. Further, the rear wheels 626b can be indexed outwardly as described above in readiness to bring passenger pod 612 back onto the power module 610 until verified and secured. In this regard, the passenger pod suspension systems can be adjusted (e.g., pod suspension airbag pressure) to accomplish the required variations upward and/or downward.

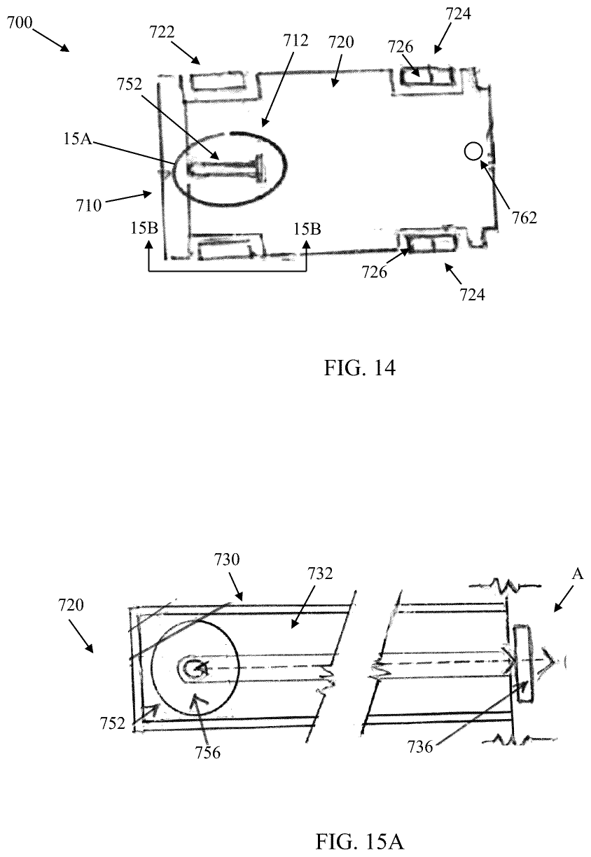

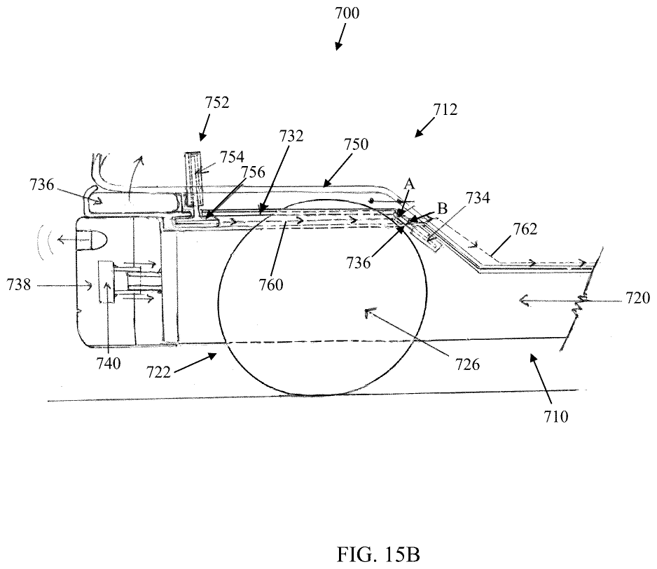

In addition to facilitating the exchange operations described above, in some examples a relationship of the front stand(s) 642 with power module 610 can assist in a partial exit operation. For example, FIG. 14 is a simplified plan view of another AV 700 in accordance with principles of the present disclosure. The AV 700 includes a power module 710 and a passenger pod 712 (referenced generally in FIG. 14, but better shown in FIG. 15B). The power module 710 can generally have any of the configurations of the present disclosure and includes a frame or chassis 720 supporting a number of wheel assemblies, including front wheel assemblies 722 and rear wheel assemblies 724. The wheel assemblies 722, 724 can assume various forms as described above and each include a driven tire or wheel 726. Though not shown, any of the suspension systems, capture and release mechanisms and/or indexing systems of the present disclosure can be provided with the power module 710, for example associated with one or more or all of the wheel assemblies 722, 724 (e.g., an indexing system as described above can be provided with each of the rear wheel assemblies 724 to effect indexing of the corresponding wheel 726). With additional reference to FIGS. 15A and 15B, the frame 720 forms or carries a ledge 730 defining a slot 732. Further, an actuator 734 is maintained by the frame 720 proximate the slot 732. In particular, and for reasons made clear below, the actuator 734 includes a piston 736 that is extendable and retractable into/out of the slot 732 at a location spatially near the front wheel assemblies 722 (e.g., the piston 736 selectively enters the slot 732 at a location that is closer to the front wheel assemblies 722 as compared to the rear wheel assemblies 724). As a point of reference, FIG. 15B illustrates additional, optional features provided with or connected to the power module 710, such as a safety airbag 736 and a bumper assembly 738 that includes an impact absorption system 740.

The passenger pod 712 can generally have any of the configurations of the present disclosure and includes an outer housing 750 and a front stand 752. The front stand 752 can include an expandable shaft 754 and a pad 756. As best seen in FIG. 15B, in a normal driving mode or arrangement of the AV 700, the front stand 752 is arranged relative to the power module 710 such that the pad 756 is captured within the slot 732 of the frame 720.

Under circumstances in which the capture and release mechanisms (not shown) are operated to release the passenger pod 712 from the power module 710 and one or more of the wheels 726 are in contact with the outer housing 750 and rotated to move the passenger pod 712 relative to the power module 710 commensurate with the descriptions above, the passenger pod 712 will move rearwardly relative to the power module 710 (e.g., leftward direction relative to the orientation of FIG. 15B). A sliding interface between the pad 756 of the front stand 752 and the slot 732 permits the front stand 752 to move/slide with the rearward movement of the passenger pod 712 as represented by arrows 760 in FIG. 15B. Under circumstances where the AV 700 is performing a partial exit operation, the actuator 734 is operated to extend the piston 736 into the slot 732 (position “A” in FIG. 15B). With continued rearward movement of the passenger pod 712, the pad 756 will slide rearwardly along the slot 732 and come into contact with the extended piston 736 at location A. This relationship is also represented at A in FIG. 15A. Bearing interface between the pad 756 and the piston 736 impedes or prevents further rearward movement of the front stand 752, and thus of the passenger pod 712. Thus, in this partial exit arrangement, the passenger pod 712 remains generally connected to the power module 710 via the front stand 752, but is rearwardly spaced from a front of the frame 720. Under circumstances where the AV 700 is performing a full exit operation or an exchange operation (e.g., the drop-off phase), the actuator 734 is operated to retract the piston 736 from the slot (position “B” in FIG. 15B). With continued rearward movement of the passenger pod 712, the pad 756 again slides rearwardly along the slot 732 and freely passes beyond the actuator 734 (represented by arrows 762 in FIG. 15B). Further rearward movement of the passenger pod 712 relative to the power module 710 can thus freely continue as described above, with the passenger pod 712 ultimately being moved entirely off of the power module 710. In some optional embodiments and as generally indicated in FIG. 14, the frame 720 can form or define an opening 762 proximate a rear side thereof and through which the pad 756 can pass to permit full transitioning of the front stand 752 to the deployed state. With the embodiments implicated by FIGS. 14-15B, the front stand 752 can be length adjusted (e.g., via a linear actuator (not shown)) to cause more friction in support of improved drag and/or lessened impact as part of a partial exit operation. Likewise, the front stand 752 can be approximately centered relative to the outer housing 750 to improve the exit or escape processes.

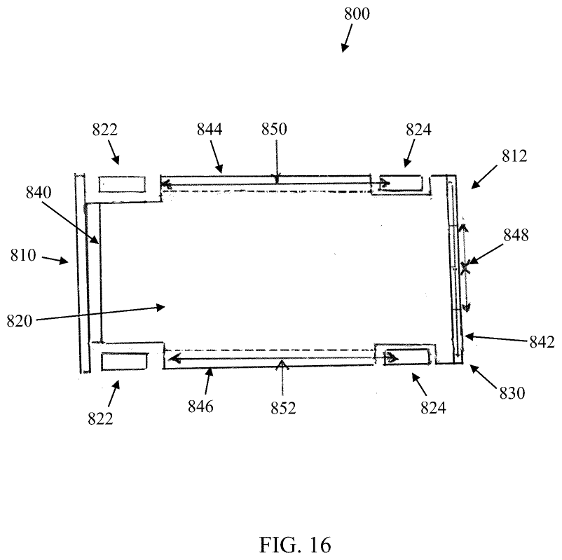

In some embodiments, the systems and methods of the present disclosure facilitate formatting of the passenger pod to provide space for a rear-only entry to reduce parts and thus costs, and offering additional space between the front and rear wheels for many internal passenger pod layouts. For example, FIG. 16 is a simplified plan view of another AV 800 in accordance with principles of the present disclosure. The AV 800 includes a power module 810 and a passenger pod 812. The power module 810 can generally have any of the configurations of the present disclosure and includes a frame or chassis 820 supporting a number of wheel assemblies, including front wheel assemblies 822 and rear wheel assemblies 824. The wheel assemblies 822, 824 can assume various forms as described above and each include a driven tire or wheel. Though not shown, any of the suspension systems, capture and release mechanisms and/or indexing systems of the present disclosure can be provided with the power module 810, for example associated with one or more or all of the wheel assemblies 822, 824 (e.g., an indexing system as described above can be provided with each of the rear wheel assemblies 824 to effect indexing of the corresponding wheel).

The passenger pod 812 can generally have any of the configurations of the present disclosure and includes an outer housing 830 and optionally one or more of the interface components of the present disclosure (e.g., front and/or rear stands as described above). The outer housing 830 is formatted (e.g., shaped) to define a front end 840 opposite a rear end 842, and opposing sides 844, 846. With the configuration of FIG. 16, the outer housing 830 forms or carries a door 848 for passenger/cargo ingress and egress to an interior of the outer housing 830 at the rear end 842. The door 848 can be secured to the outer housing 830 in various manners (e.g., hinged door, sliding door, etc.). Regardless, the outer housing 830 is characterized by the absence of a door or similar opening at either of the opposing sides 844, 846. This construction renders a floor surface of the outer housing 830 to be uninterrupted along the opposing sides 844, 846, thus presenting a more uniform or continuous surface (represented by arrows 850, 852) for contact with wheels during the exit and/or exchange operations described above.

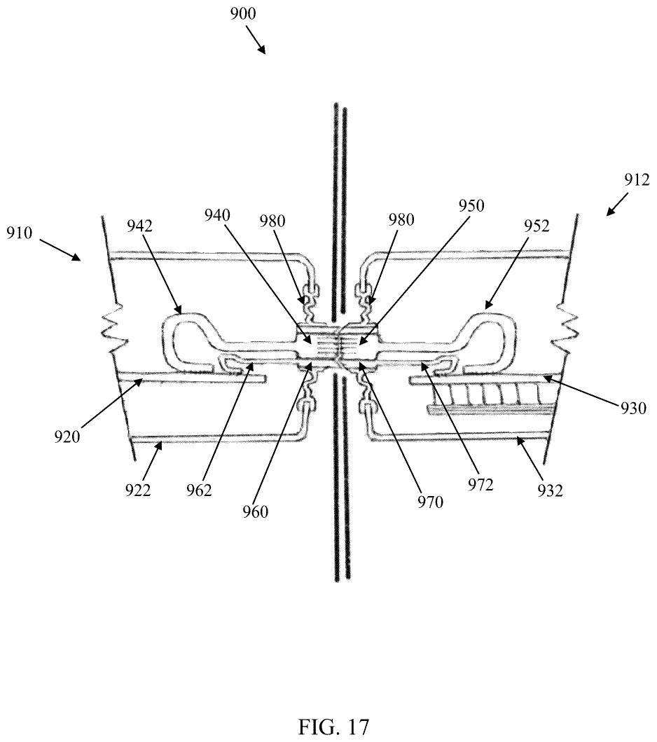

Any of the AVs of the present disclosure can optionally incorporate a separable wiring extending between the power module and the passenger pod. As a point of reference, when the passenger pod separates from the power module it is desirable that the wiring between the two segments of a 2-stage AV also separate without causing substantial exiting resistance and works to separate at sufficient speed. Further, it is desirable that the two wiring ends are also easily separated and reconnected. With this in mind, portions of a wiring connection system 900 useful with the AV's of the present disclosure is shown in FIG. 17, and in particular between a power module 910 and a passenger pod 912. In general terms, the wiring connection system 900 is an automated self-aligning electromechanical connection and disconnect (optionally low-energy) for AV separation and reconnection between wiring/circuitry components of the power module 910 and the passenger pod 912 during safety exit and/or exchanges operations.

FIG. 17 generally illustrates electrical components of the power module platform 630 (e.g., an AV processor, etc.) carried by a collector circuit board 920 that is maintained within a case 922. Similarly, electrical components (e.g., lighting, sensors, power accessories, wires, etc.) maintained by a collector circuit board (optionally including processing) 930 of the passenger pod 912 as maintained within a case 932 are also generally shown. With this in mind, the wiring connection system 900 includes a power module magnetic connector portion 940, a passenger pod connector portion 950, a power module electromagnetic connector/switch portion 960, and a passenger pod electromagnetic connector/switch portion 970.

The power module magnetic connector portion 940 is electrically connected to the power module circuit board 920 via a power module flexible main wire loop 942, and extends to an opening in the power module case 922. The passenger pod magnetic connector portion 950 is electrically connected to the passenger pod circuit board 930 via a passenger pod flexible main wire loop 952, and extends to an opening in the passenger pod case 932. The magnetic connector portions 940, 950 have complementary shapes and serve/operate to magnetically couple to one another, for example at lower power. When connected, the magnetic connector portions 940, 950 serve to electrically connected the power module main wire loop 942 with the passenger pod main wire loop 952, and thus the power module circuit board 920 with the passenger pod circuit board 930.

The electromagnetic connector/switch portions 960, 970 have complementary designs and are operable at high power. The power module electromagnetic connector/switch portion 960 is electrically connected to a flexible secondary wire loop 962 that in turn is electrically connected to the power module collector circuity board 920. The passenger pod electromagnetic connector/switch portion 970 is electrically connected to a flexible secondary wire loop 972 that in turn is electrically connected to the passenger pod collector circuit board 930. The flexible wires 962, 672 operate to provide power to the corresponding electromagnetic connector/switch portion 960, 970.

The complementary shapes of the magnetic connectors 940, 950 and of the electromagnetic connector/switch portions 960, 970 promote self-alignment between the magnetic connectors 940, 950 and between the electromagnetic connector/switch portions 960, 970 when brought into close proximity of one another (and with power being applied to the electromagnetic connector/switch portions 960, 970). For example, the electromagnetic connector/switch portions 960, 970 can have a complementary, chamfered shape. With these and related embodiments, when the electromagnetic connector/switch portions 960, 970 are close to one another, but not in perfect alignment, and then energized, the electromagnetic connector/switch portions 960, 970 are strongly attracted to one another and caused to come into alignment due to complementary, chamfered shapes. In some embodiments, the wiring connection system 900 can include one or more additional features that further promote this self-alignment, for example flexible, elastomeric framework 980 that connected the electromagnetic connector/switch portions 960, 970 with corresponding case 922, 932.

The optional wiring connection system 900 effectively provides two non-limiting examples of releasable power module/passenger pod wiring connection formats of the present disclosure that permit automated separation and reconnection.

As described above, some of the automated passenger pod release and transitioning systems and methods of the Carroll '474 Patent entail use of the AV's motors and tires to move a released passenger pod relative to the power module (and/or vice-versa). It would be helpful if a modular release of the passenger pod (or pod module) could be sent on an AI determined safer path, at least moved away from immediate or direct impact or provide room for additional buffering means. If so, this now fully or partially escaped passenger pod from the power module can serve as an enclosure that provides ongoing, improved collision outcomes. It offers the option to provide safety shell enclosures of composites vs. crushing metal and weldments. This automated safety exiting also could provide the weather enclosure when exchanging passenger pods from one to another or in storage when that passenger pod is not in use. Features of the present disclosure extend this to the building of the passenger pod using an indexing of the suspension that is out of the way for these actions means to nest the mechanics, automatically capture and release the passenger pod from the power module, remove the rear tires for passenger pod movements and the addressing of the tire to the now released passenger pod for the exchange or exit sending. Aspects of the present disclosure provide ways to make these exchanges and exits automatic using a nested in power module floor system. This automated internally-based robotic-like system also features the use of programing to create the ability for the user to change from one system to another using a smart phone. The control for this system also provides full or partial exiting permitting AI to control these actions at very fast responses to fully or partially avoid an otherwise unavoidable collision event. This can be termed Physical AI. It empowers AI to avoid totally an impact or, at a minimum, improve upon the passenger outcomes by redirect, physical inertia reduction or improved coefficient of drag. It can improve upon the protection of the passengers or contents (e.g., via contact with the safety airbag instead of a metal structure). Moreover, AI can be employed to determine how best to react for the best outcomes. The exchange value is automatically based on the digitally expressed desires of the user to proceed from one passenger pod to the next. For example, a pickup to a SUV, a low-slung racer to a high-top RV or van as a mobile office, can be automatically and autonomously performed as desired and completed in most any location in a few minutes. This can be done to swap power modules for any reason, including quickly obtaining a fully charged power module or to leave a needed charge when used for vehicle-to-home power.

The systems and methods of the present disclosure enhance the viability of AV's through horizontal modularity with autonomous separation. To this end, power modules are likely to last much longer and outlive many passenger pod enclosures. New battery options are available that last millions of miles. Full-length power module platform structures are possible with next-gen giga presses and make very long-lasting, coated alloy castings. In mirror cavity forms, they become strong sandwiches that also enclose batteries using fewer parts. Integrated, adjustable airbags suspend enclosure and wheels. Platforms nest wheel indexing for capture, release and send actions. Nestable Lucid motor diameter with internal universal joint can add drive-shaft sleeves for indexing; KIA near-wheel motors can be mounted on an indexing shelf; or YASA/Mercedes in-wheel motors direct drive all provide out-of-the-way rear wheel drive options. These increase cabin area of the passenger pod and horizontal openness for exchange or escape. Potential extended financing for multigenerational platform life means lower buyer monthly payment than other options. Potential for pod-only loan and hiring power platform rental services are also promoted by the present disclosure. In this regard, a “always fully charged” power module is available to users on call or preplanned for work or other routine activities taking advantage of the 95% unused vehicle times. This, in turn, provides a solution for apartment renters or condominium owners without AV charging availability. As an additional benefit, long-trip, two-minute full-power platform preplanned exchanges can occur.

Features of the present disclosure further provide AI extended safety values. For example, expanded traditional AV impact avoidance is enabled (e.g., (improvement when partial or full escape is unnecessary or unavailable). In some examples, AI determines best outcomes from improving incident using reverse polarity and/or total wheel ground contact over the whole circumference of the power modules wheel surface using best reversal speed, whether continuous or intermittent. Additionally or alternatively, AI determines if variable amounts at each wheel can perform additional steering support to reduce inertia. improved angle of impact, and/or to achieve the release orientation dictated by an AI determined safety path.

In addition, partial exit operational modes of the present disclosure provide enhanced safety. AI determines best outcome from horizontal release of enclosure/passenger pod and activates related systems. This can include one or more of: 1) full brake all wheels; 2) release the passenger pod from the power module; 3) reverse polarity of the rotating wheels to partially send the passenger pod using a limited horizontal amount of freedom towards the coming impact direction; 4) contact tire upon the released passenger pod optionally employing wheel indexing (in or out horizontally, vertically, or in combination); 5) inflate the safety airbag in the created space between the power module frame and the passenger pod and/or the oncoming impacting surface to absorb inertia. AI can determine the additional application of wheel contact and motion upon the horizontally released enclosure or pod module to help reduce inertia during impact or with variable amounts at various times or optionally without the use of the airbag depending on AI analysis before, during or after an impact event. AI can determine the timing and amount of horizontally created partial escape space. This includes the between pod module and power platform and/or colliding surface for best AI determined passenger outcomes.

Full exit modes of operation can include AI using the preplanned (nested time value) safety exit path from the ongoing analysis as the AV moves along a route. AI determines a full exit provides the best passenger outcome. The full exit mode of operation is then implanted and can include: 1) brakes applied; 2) passenger pod is released; 3) motor polarity at the wheels is reversed; 4) wheels are placed in contact with the released passenger pod; 5) the passenger pod is sent on the safety path using AI controlled front wheel steering, and optional variables using independent wheel speeds or direction; when the passenger pod is on the ground, direction and speed is made by AI adjusting the amount of contact using independent processor-controlled of stems or legs with pads upon the ground; 6) safety airbag may be used during full exit as a precautionary measure.

AV buyers/users desire autonomous vehicles with the ultimate in safety, lowest effective cost, most convenience, aesthetic options, changes for changing purposes or applications and consideration for timing variables. The systems and methods of the Carroll '474 Patents and the present disclosure are based on inventive use of existing AV drive trains and modular design means. This non-limiting and partial list of methods provide these desired values surrounding creative use of horizontal modularity with autonomous separation under the control of the user for automated implementation when done for convenience and by AI for automated extensions of Physical AI for safety when these inventions are fully applied.

The new automated retention and release using the indexing of a combination of both Pod Module and Wheel suspension components while also providing address of the tire upon a released Pod Module for exchange and exit. This means a new system will provide critical usefulness for AI to implement activity based on live status findings to release, recapture and send for exchange and emergency escape processes. This includes user multi-purpose Pod exchange value direction and implementation. It fits well with features of the Carroll '474 Patent that provide means of onboard motors and tires activation. The system also uses onboard processing, sensors, suspension and other available components to provide this new enclosure activity capacity using this new design and automation built method. It can do so for individual modules when together (wired) or separated (wireless) and moving independently or stationary to prepare for active coordination.

This automated design provides a new way to improve impact physics and will uniquely reduce injuries and save lives using escape in the worst of circumstances. Physics are applied on this new shape in ways that reduced inertia. Inertia is reduced because this body format and operation for safety has less weight, reduced speed and increased drag on the ground when released as an escape pod. The use of sensors and AI-based algorithm onboard processing can dictate operational modes and directions based on the safety path or safety process amount or type. The nested escape path planning will better send the passengers toward better outcomes and do so with more time to perform the AI-directed action. It can fit the use of support stands or stems as outriggers and steer by applying various pressure on the ground. Features of the present disclosure substantially improve the process by removing the impeding tire and common suspension intrusion from the exit or retrieval process areas, and integrates suspension for both the passenger pod and the wheel, and optionally the capture and release during the indexing motion, to perform the sending and retrieval of a passenger pod.

This same value premise fits the exchange system making a simpler and lighter form for indexing and movement from the power module platform. It will be user directed anywhere at any time through the multigenerational battery and motor life. The lighter, stronger enclosure is advantageous for safety, independent station capable and ease of exchange as well as providing the option for more aesthetic or for application purpose specific passenger pod replacements.

This system greatly lowers the high-cost and time-to-market to OEMs versus stamping plant dies and presses if the system is used with composite components.

It permits automated assembly in robotic cells or support assembly zones. The completed passenger pods and power modules of the present disclosure can optionally be automatically assembled at the OEM's vehicle assembly line.

The system provides convenience to meet the user's changing application needs and desires by exchanging the pod module most anywhere and anytime in just a few minutes.

One optional benefit of the systems and methods of the present disclosure is the combination of both passenger pod-to-power module suspension and wheel suspensions on a single indexing slide per tire application. The twin-rear wheel action helps the tire to passenger pod surface contact for sending. It also optionally provides upward force during the rotation to reduce passenger pod-to-power module contact and friction. Optionally, the sides of the passenger pod may have less of a shelf for contact or potentially just using the curve of the passenger pod side to have sufficient contact. In the application of the vertical indexing, the bottom of the passenger pod serves as the tire contact surface for swap or exit operations (and can be weather protected). The indexing piston or linear actuator may use programming to help coordinate as a pair to effectively a squeeze-type force onto the passenger pod force for a possibly more-assured motion.

The processes for using a multiple airbag suspensions for both the passenger pod-to-power module and the wheel mounted on one movable surface (e.g., the slide member or drawer) to use one activator piston or linear actuator sequentially such that in one motion, there is release of the passenger pod, indexing of the tire out of the way, and placement of the tire to a send/contact position (or a reverse order of operational steps) to perform an exchange operation as described above.

Additional aspects of the present disclosure include the consideration of or optional application for an additional mechanical means to implement rear tire indexing. The indexing is both outward and inward for both rear tires and is contemplated as using a single linear actuator with linkage to both sides. As a non-limiting example this single linear actuator piston could be located mid-vehicle and attached both ways using a scissoring linkage that further attaches to the sliding airbag slides. This by extension or contraction extends or contracts both rear tires to provide exchange or escape application using the tire relocation and rotation. All mechanical means is nested into the power module thickness or at least the top being flush with the top of the power module. This location limitation provides a clear passageway for the passenger pod to have a full X/Y usable floor plan from the at least back of the front tires while still providing the contact means of tires to address the released passenger pod's sides. This single linear actuator (typical) includes a single squeezing source for the two tires. This design is like the two-linear actuators (shown) as it includes variations of the linear actuator pressure based on passenger pod progress for various applications as confirmed by sensors, processor and software. This single linear actuator with mechanical means provides a two-way sliding release, connect and position for movement devices to improve the coordination as well as reduce cost of a dual linear actuator solution. In any case, the single actuator promotes the tire contact of a single embedded to power module motor, near-wheel motor or in-wheel motor that applies the correct tire direction using polarity to move a released passenger pod to or from the power module for partial or full escape or exchange on/off activities. One additional non-limiting means for two moving shelves to provide release/connect and tire send variations using a single mechanical means is to use a cable (typical) extensions from a single actuator to connect to each of the two tire indexing systems. One further non-limiting method is to use a single linear actuator with dual pistons extending in opposing directions.

One additional non-limiting method is to select one of the inward, outward or vertical tire address methods based on the thickness of the frame of the power module. For example, if the spacing for the wheel well for a particular passenger pod and power module design requires too great a climb to move the pod sufficiently and quickly then the outward tire address method may be most appropriate. If the passenger pod uses a more volume required battery, like a sodium ion type, then the remaining rise to contact the passenger pod body bottom is reduced so an inward or vertical-only address method may suffice. One further non-limiting method is to use a compliant electromechanical assurance feature in conjunction with a compliant fitting and optional flex circuitry to permit the automated connect and disconnect of the wiring between the power module and the passenger pod. In a further non-limiting feature of the wired connect the system will monitor the disconnect and connect to activate wireless between the modules to continue the cooperative features of the exchange and escape processes. In one additional non-limiting method is where the power module is composed of two facing alloy giga-castings to enclose or provide attachments for some of the features disclosed herein. This may include enclosing the battery, provide mounting means for the various types of indexing options and stem access for addressing the ground before the passenger pod completely leaves the power module or to nest during the retrieval process.

Although the present disclosure has been described with reference to preferred embodiments, workers skilled in the art will recognize that changes can be made in form and detail without departing from the spirit and scope of the present disclosure.

What is claimed is:

1. An autonomous vehicle comprising:
a power module including a frame supporting at least one motor, at least one wheel driven by the motor, and an indexing system configured to move the at least one wheel at least one of laterally and vertically relative to the frame;
a passenger pod including an outer housing releasably coupled to the power module;
a capture and release mechanism configured to selective decouple the passenger pod from the power module;
at least one sensor; and
a controller configured to, in response to detecting an imminent collision using the at least one sensor, actuate the capture and release mechanism to decouple the passenger pod from the frame and actuate the indexing system to position the at least one wheel in contact with the outer housing and propel the passenger pod away from the power module along a safety path determined by the controller.

2. The autonomous vehicle of claim 1, wherein the indexing system includes a spline shaft coupling the motor to the at least one wheel, the spline shaft being extendable and retractable to laterally displace the at least one wheel relative to the frame.

3. The autonomous vehicle of claim 1, wherein the controller is further configured to coordinate rotation of at least two wheels of the power module in opposing directions to exchange the passenger pod with another passenger pod.

4. The autonomous vehicle of claim 1, wherein the passenger pod further includes at least one extendable stand carried by the outer housing and configured to transition to a deployed state following decoupling of the passenger pod from the power module.

5. The autonomous vehicle of claim 4, wherein the at least one extendable stand is further configured to at least one of steer, level, capture, or slow motion when extended from the outer housing.

6. The autonomous vehicle of claim 1, further comprising a wheel suspension airbag coupled to the at least one wheel, wherein the controller is configured to prompt adjustment of air pressure in the wheel suspension airbag to vary contact force between the at least one wheel and the passenger pod.

7. The autonomous vehicle of claim 6, wherein the wheel suspension airbag includes a dual-slot configuration for capture and release between the power module and the passenger pod.

8. The autonomous vehicle of claim 1, further comprising a pod suspension airbag between the passenger pod and the power module.

9. The autonomous vehicle of claim 1, wherein the indexing system is nested within the power module to avoid obstructing the passenger pod.

10. The autonomous vehicle of claim 1, further comprising a stem selectively extending from the frame to elevate a rear side of the power module as part of a passenger pod module exchange operation.

11. The autonomous vehicle of claim 1, wherein the capture and release mechanism includes a solenoid actuator with a pin limits horizontal motion of the passenger pod.

12. The autonomous vehicle of claim 11, wherein passenger pod includes at least one stand that is guided by rails and includes compliance for alignment during recapture.

13. The autonomous vehicle of claim 1, wherein the passenger pod includes an integrated computing device for post-decoupling control of stems, sensors, and communications carried by the outer housing.

14. The autonomous vehicle of claim 1, wherein the indexing system includes a slide member arranged to be laterally slidable relative to the frame.

15. The autonomous vehicle of claim 1, wherein the motor is an in-wheel motor integrated with the wheel.

16. The autonomous vehicle of claim 1, further comprising a plurality of sensors arranged and configured to signal information indicative of progress of movement of the passenger pod during at least one of an exchange operation and an exit operation.

17. The autonomous vehicle of claim 1, wherein the controller is programmed to coordinate rotational speeds of wheels of the power module to direct motion during at least one of an exchange operation and an exit operation.

18. The autonomous vehicle of claim 1, further comprising a suspension system including an airbag with airbag compartments, and further wherein the suspension is configured to adjust a camber of the at least one wheel by applying differential air pressure in the airbag compartments.

19. The autonomous vehicle of claim 1, wherein the reversal of the at least one motor's polarity to direct the at least one wheel and so the amount of wheel speed applied to the ground can be varied between at least two wheels of the power module.

20. The autonomous vehicle of claim 1, wherein the outer housing defines a front end opposite a rear end, and opposing sides, and further wherein the passenger pod further includes a door arranged at the rear end such that a floor of the outer housing is uninterrupted along each of the opposing sides in extension between the front and rear ends.
